(19) United States
(12) Patent Application Publication
(10) Pub. No.: US 2015/0273247 A1
(43) Pub. Date: Oct. 1, 2015

(54) Mine Escape Self-Rescuer System and Method

(71) Applicants: John J. Reinmann, JR., Alpharetta, GA (US); Gregory Paton-Ash, Marietta, GA (US)

(72) Inventors: John J. Reinmann, JR., Alpharetta, GA (US); Gregory Paton-Ash, Marietta, GA (US)

(73) Assignee: STRATA PRODUCTS WORLDWIDE, LLC, Sandy Springs, GA (US)

(21) Appl. No.: 14/242,362

(22) Filed: Apr. 1, 2014

(51) Int. Cl. A62B 7/04; A62B 25/00; A62B 18/02; A62B 18/08; A62B 9/02; A62B 9/06

(52) U.S. Cl. CPC A62B 7/04; A62B 9/02; A62B 9/06; A62B 18/02; A62B 18/08; A62B 25/00

(57) ABSTRACT

A method for a miner in a mine to breathe in the mine having the steps of turning on an on off valve of a first air cylinder while in the mine so air flows from the first air cylinder connected to a first port of a connector to and through a third port of the connector and to a facemask on the miner's head. There is the step of the miner breathing air in the facemask from the third port. There is the step of connecting a second air cylinder to a second port of the connector. There is the step of turning on an on off valve of the second air cylinder while in the mine so air flows from the second air cylinder to and through the third port and to the facemask so the miner is breathing air in the facemask from the first and second air cylinders. There is the step of separating the first air cylinder from the first port while in the mine. A system for a miner in a mine to breathe in the mine.

### FIELD OF THE INVENTION

The present invention is related to a self-rescuer for a miner in a mine that has a connector which allows the miner to quickly and easily switch out a depleted pressurized air cylinder with which the miner is using to breathe as he is trying to escape the mine with a second pressurized air cylinder that is fully pressurized without having to hold his breath or expose his lungs to the mine atmosphere. (As used herein, references to the “present invention” or “invention” relate to exemplary embodiments and not necessarily to every embodiment encompassed by the appended claims.) More specifically, the present invention is related to a self-rescuer for a miner in a mine that has a connector which allows the miner to quickly and easily switch out a depleted pressurized air cylinder with which the miner is using to breathe as he is trying to escape the mine with a second pressurized air cylinder that is fully pressurized without having to hold his breath or expose his lungs to the mine atmosphere and to also support buddy breathing with a second miner.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

All miners carry a self-rescuer device on their belts. These units are used when the atmosphere is not life supporting, i.e., either the oxygen content is too low or the air contains deadly levels of carbon monoxide or other hazardous chemicals.

The self-rescuers typically are a “closed loop” system that provides oxygen to the inhaled breath and removes carbon dioxide from the exhaled breath. The exhaled oxygen is recovered and re-used. Make-up oxygen can be provided by a controlled chemical reaction or by a canister of high pressure oxygen. The units can provide as little as 10 minutes of breathing oxygen up to 60 minutes on the units commercially available today.

As a miner attempts to escape the mine after an event, additional self-rescuers are positioned at specific intervals along the escape paths. Miners are taught to exchange a spent unit for a fresh unit. This change over process is fraught with difficulty and danger. The process requires an exacting sequence to avoid taking a breath of contaminated air while changing from one mouthpiece to another. The mouthpiece also eliminates the ability to communicate with other miners.

In the past ten years, an open loop self-rescue device has made inroads into the mine escape process. This technology is commonly used by firefighters. Unlike the closed loop system described above, this system uses compressed air to provide the necessary oxygen. Excess air and exhaled CO2 are vented typically from a full facemask and therefore no scrubbing of CO2 is necessary. While much simpler in design, the trade-off is size: The compressed air systems require a much larger cylinder for the same rated duration.

A re-charge station adapted from firefighting technology has been introduced into the mining applications. This idea uses a set of cascading high pressure cylinders (typically 6000 psi to charge a 4500 psi tank) and a quick connect fitting to connect the miners cylinder to the re-charging system. There are several drawbacks to this system: highly complex cascading systems are costly; the fill time can be anywhere from 60 seconds to over three minutes; the number of connecting ports are limited; due to the heat of compression the portable cylinders cannot be filled to their full 4500 psi capacity; unusable air is left in the cascading cylinders; spacing of these units are limited to a maximum of 30 minutes travel time apart.

### BRIEF SUMMARY OF THE INVENTION

A method for a first miner in a mine having an atmosphere to breathe in the mine comprising the steps of turning on an on off valve of a first air cylinder while in the mine so air flows from the first air cylinder connected to a first port of a connector to and through a third port of the connector and to a first facemask on the first miner's head. There is the step of the first miner breathing air in the first facemask from the third port. There is the step of connecting a second air cylinder to a second port of the connector. There is the step of turning on an on off valve of the second air cylinder while in the mine so air flows from the second air cylinder to and through the third port and to the first facemask so the first miner is breathing air in the first facemask from the first and second air cylinders. There is the step of separating the first air cylinder from the first port while in the mine.

The present invention pertains to a self-rescuer system for a first miner and a second miner in a mine having an atmosphere. The system comprises a first pressurized gas cylinder. The system comprises a second pressurized gas cylinder. The system comprises a first facemask that completely encompasses the first miner's eyes, nose and mouth and encloses the first miner's face so a protected environment within the first facemask is created for the first miner to breathe. The system comprises a connector having a first port which connects with the first pressurized gas cylinder, a second port which connects with the second pressurized gas cylinder, and a third port which connects to the first facemask through which gas from either the first port or second port is provided to the first facemask for the first miner to breath.

The present invention pertains to a self-rescuer system for a first miner and a second miner in a mine having an atmosphere. The system comprises a first pressurized gas cylinder. The system comprises a second pressurized gas cylinder. The system comprises a first facemask that completely encompasses the first miner's eyes, nose and mouth and encloses the first miner's face so a protected environment within the first facemask is created for the first miner to breathe. The first facemask supporting closed loop breathing and open loop breathing and having a changeover valve to convert from closed loop breathing to open loop breathing. The first facemask having a mouthpiece that is spit out by the first miner when the first facemask is converted from closed loop breathing to open loop breathing. The system comprises a second facemask that completely encompasses the second miner's eyes, nose and mouth and encloses the second miner's face so a protected environment within the second facemask is created for the second miner to breathe. The second facemask supporting closed loop breathing and open loop breathing and having a changeover valve to convert from closed loop breathing to open loop breathing. The second facemask having a mouthpiece that is spit out by the second miner when the second facemask is converted from closed loop breathing to open loop breathing. The system comprises a connector having a first port which connects with the first pressurized gas cylinder, a second port which connects with the second pressurized gas cylinder, a third port which connects to the first facemask through which gas from either the first port or second port is provided to the first facemask for the first miner to breath, and a fourth port which connects with the second facemask through which gas from either the first port or second port is provided to the second facemask for the second miner to breath simultaneously while gas is provided to the first facemask.

The present invention pertains to a method for a first miner and a second miner in a mine having an atmosphere to breathe in the mine. The method comprises the steps of putting a first facemask on the first miner that completely encompasses the first miner's eyes, nose and mouth and encloses the first miner's face so a protected environment within the first facemask is created for the first miner to breathe. The first facemask supporting closed loop breathing and open loop breathing and having a changeover valve to convert from closed loop breathing to open loop breathing. The first facemask having a mouthpiece that is spit out by the first miner when the first facemask is converted from closed loop breathing to open loop breathing. There is the step of connecting a first port of a connector with a first pressurized gas cylinder. The connector also having a second port which connects with a second pressurized gas cylinder, a third port which connects to the first facemask through which gas from either the first port or second port is provided to the first facemask for the first miner to breath, and a fourth port which connects with a second facemask on the second miner through which gas from either the first port or second port is provided to the second facemask for the second miner to breath simultaneously while gas is provided to the first facemask. There is the step of connecting the third port of the connector with the first facemask. There is the step of turning on an on off valve of the first air cylinder so air flows from the first air cylinder to and through the third port and to and through the mouthpiece. There is the step of the first miner spitting out the mouthpiece in his mouth and breathing air in the first facemask from the mouthpiece. There is the step of connecting the second air cylinder to the second port. There is the step of turning on an on off valve of the second air cylinder so air flows from the second air cylinder to and through the third port and to and through the mouthpiece. There is the step of separating the first air cylinder from the first port. There is the step of connecting the fourth port to the second facemask on the second miner so air from the connector flows through the fourth port to the second facemask. There is the step of the second miner breathing air in the second facemask from the connector simultaneously while the first miner is breathing air from the third port.

The present invention pertains to a method for a first miner in a mine having an atmosphere to breathe in the mine. The method comprises the steps of putting a first facemask on the first miner that completely encompasses the first miner's eyes, nose and mouth and encloses the first miner's face so a protected environment within the first facemask is created for the first miner to breathe. There is the step of connecting a first port of a connector with a first pressurized gas cylinder. The connector also having a second port which connects with a second pressurized gas cylinder, and a third port which connects to the first facemask through which gas from either the first port or second port is provided to the first facemask for the first miner to breath. There is the step of connecting the third port of the connector with the first facemask. There is the step of turning on an on off valve of the first air cylinder so air flows from the first air cylinder to and through the third port and to the first facemask. There is the step of breathing air in the first facemask from the third port. There is the step of connecting the second air cylinder to the second port. There is the step of turning on an on off valve of the second air cylinder so air flows from the second air cylinder to and through the third port and to the first facemask. There is the step of separating the first air cylinder from the first port.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1a is a schematic representation of the system of the present invention for a single miner.

FIG. 1b is a schematic representation of the system of the present invention for two miners with buddy breathing capability.

FIG. 2 is a schematic representation of recharge stations and a change over station in a mine.

FIG. 3 shows one embodiment of the system of the present invention.

FIG. 4 shows a connector having a first air cylinder and a second air cylinder connected to the connector.

FIG. 5 shows one embodiment of the system of the present invention without the second air cylinder.

FIG. 6 shows the connector having only the first air cylinder connected to it.

FIG. 7a shows an SCSR.

FIG. 7b is a block diagram of an SCSR with a facemask and mouthpiece.

FIG. 8 is a schematic representation of a first embodiment of the inflow hose connected to the outflow hose of a SCSR.

FIG. 9 is a schematic representation of a second embodiment of the inflow hose connected to the outflow hose of a SCSR.

### DETAILED DESCRIPTION OF THE INVENTION

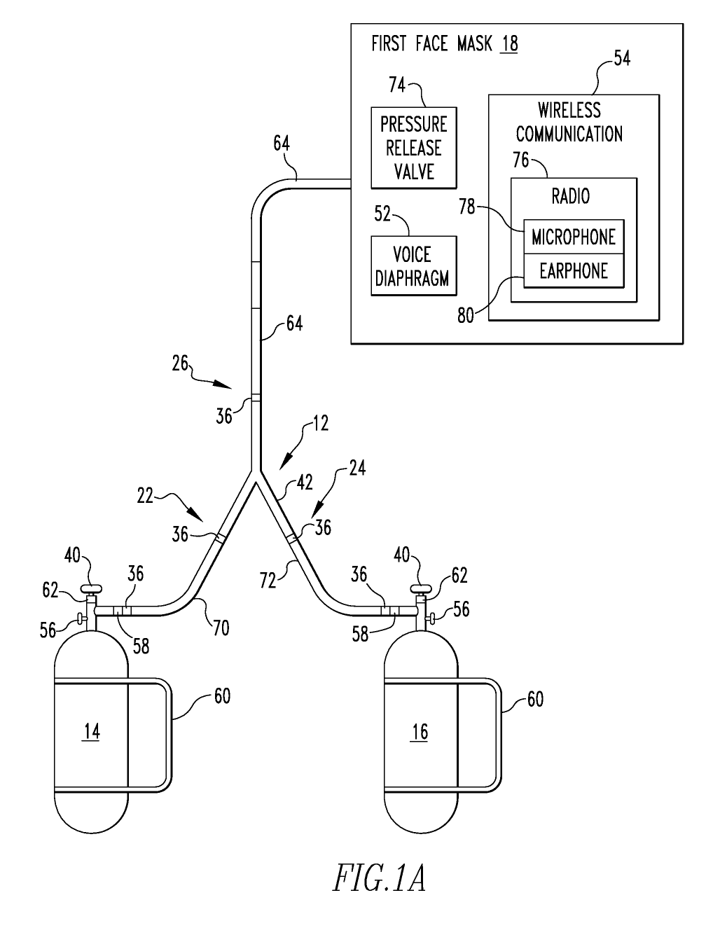

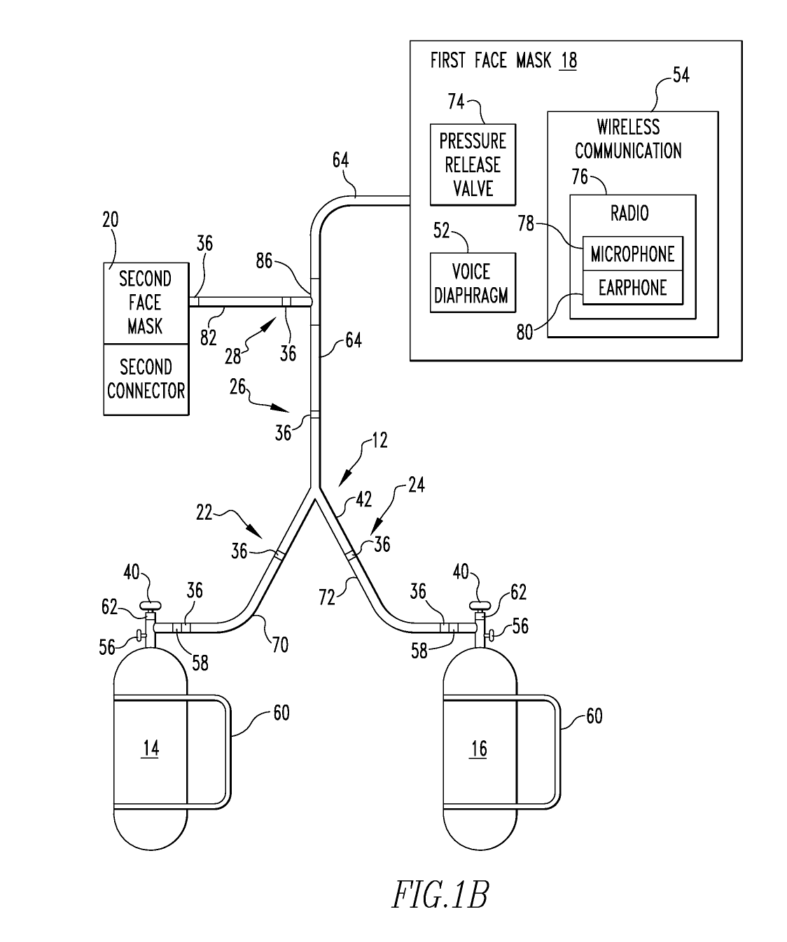

Referring now to the drawings wherein like reference numerals refer to similar or identical parts throughout the several views, and more specifically to FIG. 1a thereof, there is shown a self-rescuer system 10 for a first miner in a mine having an atmosphere. The system 10 comprises a first pressurized gas cylinder 14. The system 10 comprises a second pressurized gas cylinder 16. The system 10 comprises a first facemask 18 that completely encompasses the first miner's eyes, nose and mouth and encloses the first miner's face so a protected environment within the first facemask 18 is created for the first miner to breathe. The system 10 comprises a connector 12 having a first port 22 which connects with the first pressurized gas cylinder 14, a second port 24 which connects with the second pressurized gas cylinder 16, and a third port 26 which connects to the first facemask 18 through which gas from either the first port 22 or second port 24 is provided to the first facemask 18 for the first miner to breath.

The present invention pertains to a self-rescuer system 10 for a first miner and a second miner in a mine having an atmosphere, as shown in FIG. 1b. The system 10 comprises a first pressurized gas cylinder 14. The system 10 comprises a second pressurized gas cylinder 16. The system 10 comprises a first facemask 18 that completely encompasses the first miner's eyes, nose and mouth and encloses the first miner's face so a protected environment within the first facemask 18 is created for the first miner to breathe. The first facemask 18 supporting closed loop breathing and open loop breathing and having a changeover valve 34 to convert from closed loop breathing to open loop breathing. The first facemask 18 having a mouthpiece 30 that is spit out by the first miner when the first facemask 18 is converted from closed loop breathing to open loop breathing. The system 10 comprises a second facemask 20 that completely encompasses the second miner's eyes, nose and mouth and encloses the second miner's face so a protected environment within the second facemask 20 is created for the second miner to breathe. The second facemask 20 supporting closed loop breathing and open loop breathing and having a changeover valve 34 to convert from closed loop breathing to open loop breathing. The second facemask 20 having a mouthpiece 30 that is spit out by the second miner when the second facemask 20 is converted from closed loop breathing to open loop breathing. The system 10 comprises a connector 12 having a first port 22 which connects with the first pressurized gas cylinder 14, a second port 24 which connects with the second pressurized gas cylinder 16, a third port 26 which connects to the first facemask 18 through which gas from either the first port 22 or second port 24 is provided to the first facemask 18 for the first miner to breath, and a fourth port 28 which connects with the second facemask 20 through which gas from either the first port 22 or second port 24 is provided to the second facemask 20 for the second miner to breath simultaneously while gas is provided to the first facemask 18.

The first facemask 18 and the second facemask 20 each may have a communication diaphragm 52 to amplify voice. The first facemask 18 and the second facemask 20 each may be fitted with wireless communication 54 to communicate with others.

The connector 12 may include a time and/or pressure gauge 56 that indicates the time or the pressure remaining in either the first cylinder 14 or the second cylinder 16. The first cylinder 14 and the second cylinder 16 may each be fitted with a quick connect fitting 36 for easy connection to or disconnection from the connector 12. The first cylinder 14 and the second cylinder 16 may each be fitted with a pressure reducing valve 58 so that connection of the first cylinder 14 and the second cylinder 16 with the connector 12 occurs at low pressure. The first cylinder 14 and the second cylinder 16 may each be fitted with a disposable sling or backpack 60 that is jettisoned with the first cylinder 14 or the second cylinder 16 when the first cylinder 14 or second cylinder 16 is disconnected from the connector 12.

The first cylinder 14 and the second cylinder 16 may each be fitted with wireless pressure transducers 62 so pressure in the first cylinder 14 or the second cylinder 16 can be remotely monitored when either the first cylinder 14 or the second cylinder 16 are in storage. The first cylinder 14 and the second cylinder 16 may be made of carbon fiber, steel or aluminum.

The present invention pertains to a method for a first miner and a second miner in a mine having an atmosphere to breathe in the mine. The method comprises the steps of putting a first facemask 18 on the first miner that completely encompasses the first miner's eyes, nose and mouth and encloses the first miner's face so a protected environment within the first facemask 18 is created for the first miner to breathe. The first facemask 18 supporting closed loop breathing and open loop breathing and having a changeover valve 34 to convert from closed loop breathing to open loop breathing. The first facemask 18 having a mouthpiece 30 that is spit out by the first miner when the first facemask 18 is converted from closed loop breathing to open loop breathing. There is the step of connecting a first port 22 of a connector 12 with a first pressurized gas cylinder 14. The connector 12 also having a second port 24 which connects with a second pressurized gas cylinder 16, a third port 26 which connects to the first facemask 18 through which gas from either the first port 22 or second port 24 is provided to the first facemask 18 for the first miner to breath, and a fourth port 28 which connects with a second facemask 20 on the second miner through which gas from either the first port 22 or second port 24 is provided to the second facemask 20 for the second miner to breath simultaneously while gas is provided to the first facemask 18. There is the step of connecting the third port 26 of the connector 12 with the first facemask 18. There is the step of turning on an on off valve 40 of the first air cylinder 14 so air flows from the first air cylinder 14 to and through the third port 26 and to and through the mouthpiece 30. There is the step of the first miner spitting out the mouthpiece 30 in his mouth and breathing air in the first facemask 18 from the mouthpiece 30. There is the step of connecting the second air cylinder 16 to the second port 24. There is the step of turning on an on off valve 40 of the second air cylinder 16 so air flows from the second air cylinder 16 to and through the third port 26 and to and through the mouthpiece 30. There is the step of separating the first air cylinder 14 from the first port. There is the step of connecting the fourth port 28 to the second facemask 20 on the second miner so air from the connector 12 flows through the fourth port 28 to the second facemask 20. There is the step of the second miner breathing air in the second facemask 20 from the connector 12 simultaneously while the first miner is breathing air from the third port 26.

The present invention pertains to a method for a first miner in a mine having an atmosphere to breathe in the mine. The method comprises the steps of putting a first facemask 18 on the first miner that completely encompasses the first miner's eyes, nose and mouth and encloses the first miner's face so a protected environment within the first facemask 18 is created for the first miner to breathe. There is the step of connecting a first port 22 of a connector 12 with a first pressurized gas cylinder 14. The connector 12 also having a second port 24 which connects with a second pressurized gas cylinder 16, and a third port 26 which connects to the first facemask 18 through which gas from either the first port 22 or second port 24 is provided to the first facemask 18 for the first miner to breath. There is the step of connecting the third port 26 of the connector 12 with the first facemask 18. There is the step of turning on an on off valve 40 of the first air cylinder 14 so air flows from the first air cylinder 14 to and through the third port 26 and to the first facemask 18. There is the step of breathing air in the first facemask 18 from the third port. There is the step of connecting the second air cylinder 16 to the second port 24. There is the step of turning on an on off valve 40 of the second air cylinder 16 so air flows from the second air cylinder 16 to and through the third port 26 and to the first facemask 18. There is the step of separating the first air cylinder 14 from the first port 22.

There may be the step of the first miner speaking into the first facemask 18 whose voice is amplified by a communication diaphragm 52 to amplify voice. There may be the step of the first miner communicating remotely with others through wireless communication 54 fitted to the first facemask 18. There may be the step of indicating on a time or pressure gauge 56 the time or the pressure remaining in either the first cylinder 14 or the second cylinder 16. There may be the step of monitoring remotely with wireless pressure transducers 62 attached to the first and second air cylinder's 16 pressure in the first cylinder 14 or the second cylinder 16 when either the first cylinder 14 or the second cylinder 16 are in storage.

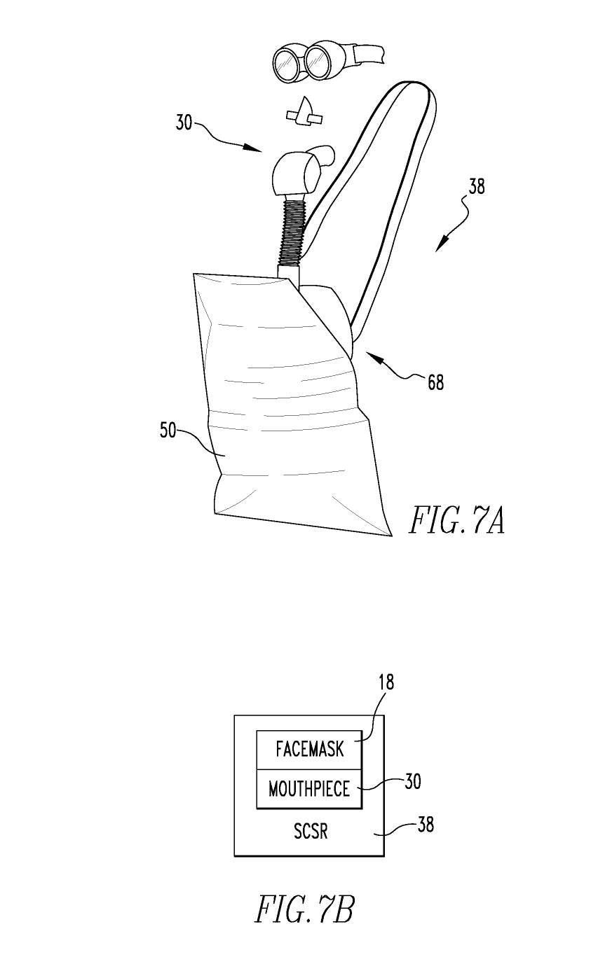

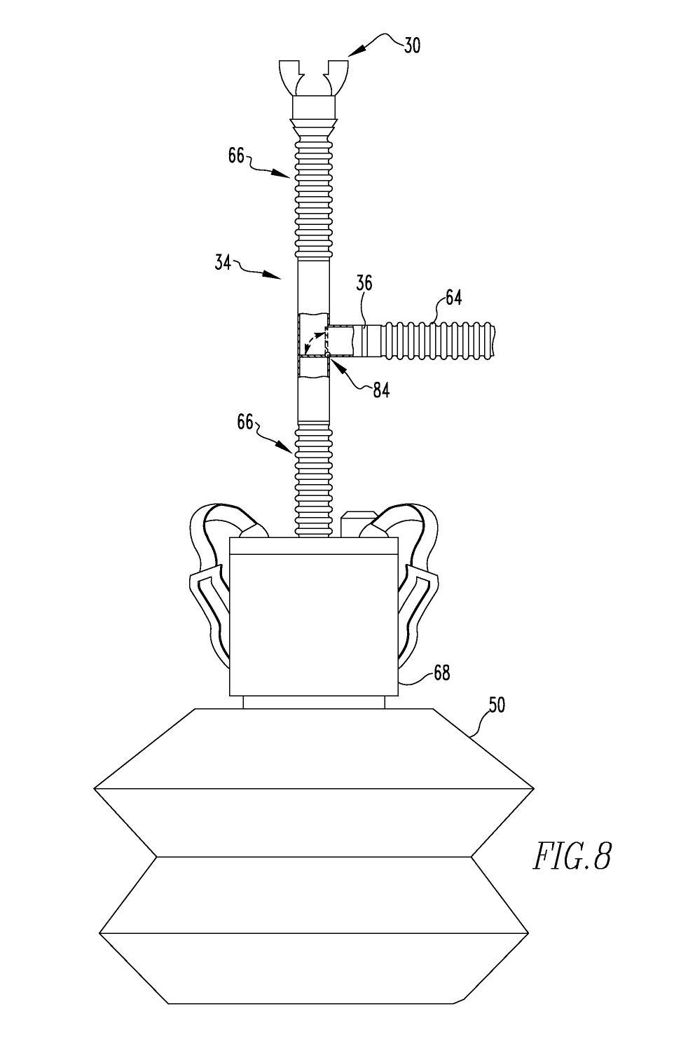

In the operation of the invention, upon an emergency occurring inside a mine, a miner will immediately activate the SCSR 32 he has on his person, typically attached to his belt. The SCSR 32, instead of having simply a mouthpiece 30 and nose clip, as shown in FIG. 7b, through which the miner will breathe in and out, there will instead be a facemask 18 with a mouthpiece 30 that the miner places into his mouth when he puts the facemask 18 on, as shown in FIG. 7b. The mouthpiece 30 will have an outflow tubing or hose 66 that extends from the mouthpiece 30 to a canister 68 that removes carbon dioxide from the miner's exhaled breath and provides oxygen to the miner by chemical reaction. The operation of the canister 68 in terms of adding oxygen and removing carbon dioxide is well known in the art. The outflow hose 66 extending from the canister 68 to the mouthpiece 30 through the facemask has a changeover valve 34 which allows an inflow hose 64 to be connected to the facemask to allow the facemask 18 to receive oxygen or air from a pressurized gas cylinder, having air or oxygen, from the third port 36.

After the SCSR 32 is activated and the facemask 18 is on the miner with the mouthpiece 30 in the miner's mouth and the miner is breathing through the mouthpiece 30 and obtaining air or oxygen from the canister 68 in closed loop mode, the miner moves to a recharge station 44 located in the mine.

In a first embodiment, the recharge station 44 will have a cache of pressurized air cylinders 14, 16, typically pressurized to 4500 PSI and possibly 5500 PSI. The air cylinders 14, 16, are stored in a steel container 46 that ideally can withstand an explosion of up to 15 PSI, to protect the contents in the container 46.

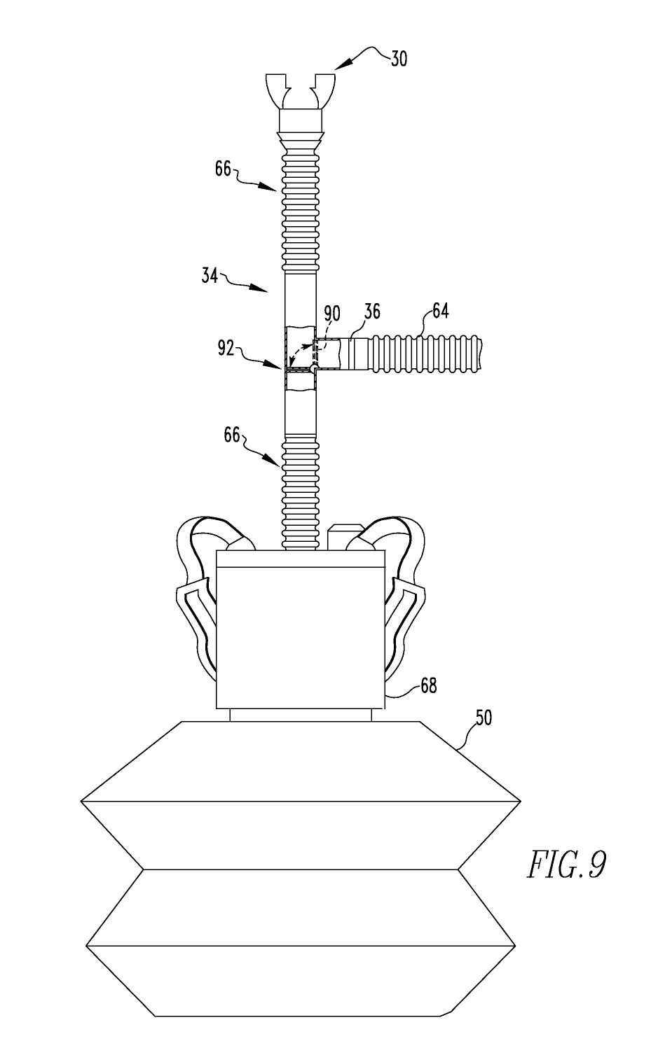

Present in the container 46 is also a cache of self-rescuer connectors 12. The connectors 12 have at least three ports, as shown in FIG. 1a. A first port 22 of the connector 12 connects to a first pressurized air cylinder 14. A second port 24 of the connector 12 connects to a second pressurized air cylinder 16. A third port 26 of the connector 12 connects to the facemask of the miner, either directly to the facemask in one embodiment, or to the changeover valve 34 in a second embodiment through the inflow hose 64, as shown in FIGS. 8 and 9 (FIGS. 8 and 9 also show a mouthpiece, but for purposes of describing this embodiment, the changeover valve is the same), to provide air from either the first port 22 or the second port 24 to the miner to breathe in the air delivered to the facemask. The connector 12 may have a fourth port 28 that connects to a hose of a second miner, if necessary, as shown in FIG. 1b, to allow a second miner to breathe air from either the first port 22 or the second port 24 simultaneously while the first miner is breathing air from either the first port 22 or the second port 24, in buddy breathing fashion. The need for by the buddy breathing may occur when the first miner is moving through the mine and is away from the recharge station 44 and comes across the second miner, who has essentially depleted his air supply.

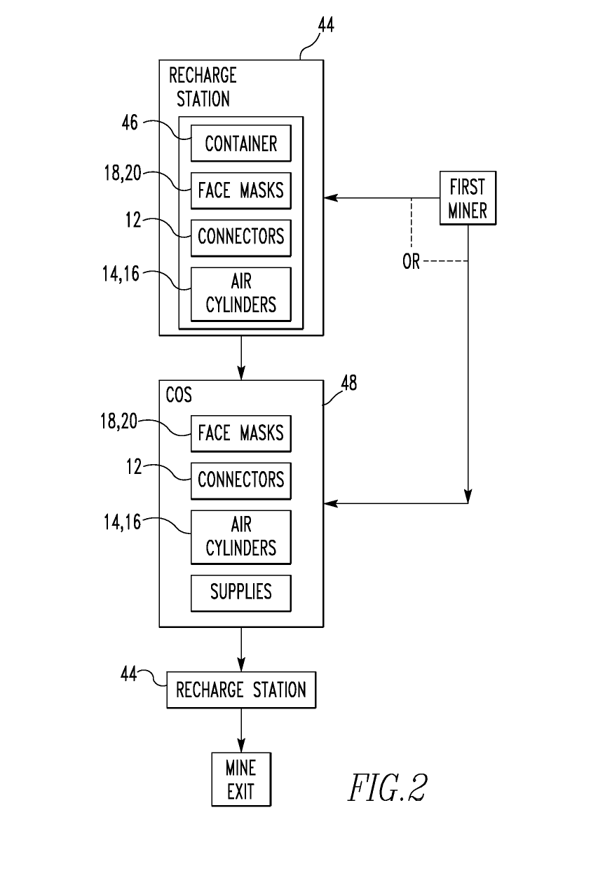

When the first miner reaches the recharge station 44, as shown in FIG. 2, the first miner will obtain a connector 12 from the container 46 and connect the third port 26 of the connector 12 to the changeover valve 34. The third port 26 of the connector 12 will have the inflow hose 64 that extends from the connector 12 to the changeover valve 34 to facilitate the connection. Furthermore, the inflow hose 64 of the third port 26 will have a quick connect fitting 36 disposed at its end to allow the third port 26 inflow hose 64 to quickly connect to the changeover valve 34. The first miner next would take a first air cylinder 14 from the container 46 and connect the first air cylinder 14 to the first port 22. The first port 22 will have a first port hose 70 with a quick connect fitting 36 to easily allow the first air cylinder 14 to be connected to the first port 22. The first miner will then open an on off valve 40 on the first gas cylinder 14 to allow air to flow from the first gas cylinder 14 through the first port 22 up into and through the third port 26 into the mouthpiece 30 in the facemask. When air is flowing through the mouthpiece 30, the first miner will then spit the mouthpiece 30 out. Air will continue to flow into the facemask from the mouthpiece 30, allowing the miner to breathe. A pressure release valve 74 in the facemask will allow any excessive pressure to vent from the mouthpiece 30.

With the mouthpiece 30 removed from the mouth of the first miner, the first miner is now able to speak to others. The facemask has a wireless communication 54, for instance a radio 76 that has a microphone 78 in the facemask for the first miner to speak into to communicate with others and an earphone 80 positioned on a strap that fits into the ear of the first miner for the first miner to hear any broadcasts to him. The transmitter and receiver of the radio are in communication with the microphone 78 and the earphone 80, respectively, and are disposed in a small enclosure on the side of the facemask. The facemask is also fitted with a communication diaphragm 52 to amplify the first miner's voice when he speaks so miners nearby to better hear him.

The first air cylinder 14 is fitted with a disposable sling or backpack 60 that facilitates the first miner caring the first air cylinder 14. The disposable sling or backpack 60 is jettisoned with the first air cylinder 14 when the first air cylinder 14 is removed from the first port 22. If desired, the first miner can take a second air cylinder 16 from the container 46 and connect the second air cylinder 16 to the second port 24 for additional air supply. The second port 24 has a second port hose 72 with a quick connect fitting 36 extending from it to allow the second air cylinder 16 to quickly be connected to the second port 24. The first miner will not open the on off valve 40 of the second air cylinder 16 when the air in the first air cylinder 14 is essentially depleted. The second air cylinder 16 also has a disposable sling or backpack 60 to facilitate the second cylinder 16 being carried by the first miner.

The purpose of the second port 24 for the second air cylinder 16, is not primarily to provide the first miner with a second air cylinder 16 to carry along with the first air cylinder 14. The weight of two air cylinders could be cumbersome and slow the first miner down, where speed and distance is desired for the first miner to try to escape from the mine. Instead, the main purpose of the second port 24 of the connector 12 is to allow the first miner to come to a second recharge station 44 and to obtain the second air cylinder 16 from a container 46 at the second recharge station 44 to replace the first air cylinder 14 that is already connected to the connector 12, but which has less or little air left in it because the first miner has traveled through the mine from the first recharge station 44. In such an instance, the first miner that only has the first air cylinder 14 connected to the first port 22 of the connector 12, and the second port 24 of the connector 12 being open, takes the second air cylinder 16 from the container 46 at the second recharge station 44 in the second air cylinder 16 to the second port 24, as explained above. In this case though, the first miner opens the on-off valve 40 of the second air cylinder 16 so air from the second air cylinder 16 is now released and flows to and through the third port 26 and into the facemask. Once the air from the second air cylinder 16 is flowing to the first facemask 18 for the first miner to breathe, the miner will then turn off the on off valve 40 of the first cylinder 14 and then use the quick connect fitting 36 to quickly and easily disconnect the first air cylinder 14 from the connector 12 and discard the first air cylinder 14. In this way, at no time is the first miner left without access to an air supply since the first air cylinder 14 is only disconnected after the second air cylinder 16 has been turned on with air from the second air cylinder 16 flowing to the facemask.

With a fresh supply of air from the newly connected second air cylinder 16, the first miner continues on his trek through the mine to the surface. Depending on how far the surface is from the current location of the first miner, the first miner may have to stop at a second or third or even fourth recharge station 44 disposed at spaced apart locations throughout the mine to the surface. With a range afforded the first miner with a full air cylinder at 4500 PSI, the miner has about 60 minutes for travel either to escape the mine by reaching the surface, reach a recognized location of safety, or a next recharge station 44 to obtain a replacement air cylinder. If the first miner needs to stop at another recharge station 44 to obtain a replacement air cylinder, then the process described above is repeated at each recharge station 44 where the first miner switches out the spent air cylinder with a full air cylinder using the open port of either the first or second port 24 to quick connect the new full air cylinder to the connector 12, turning the new full air cylinder on, and then using the quick connect fitting 36 to disconnect the spent air cylinder and discarding the spent air cylinder so the first miner can continue on his way.

If at any time while the first miner is traveling through the mine, the first miner meets a second miner that is in need of air, and the connector 12 the first miner is using has the fourth port 28, the second miner can connect a buddy hose 82 that has a quick connect fitting 36 at both ends to the fourth port 28 of the connector 12 of the first miner and to the open port of either the first port 22 or the second port 24 of the connector 12 of the second miner. Once connected in this manner, a second miner is able to receive air from the first air cylinder 14 connected to the first port 22 or the second air cylinder 16 connected to the second port, which then flows through the fourth port 28 of the first miner's connector 12 to the first port 22 or second port 24 of the second miner's connector 12, depending on which one the buddy hose is connected with, and through the third port 26 of the second miner's connector 12 into the second miner's facemask 20. In the alternative, if the second miner does not have a connector 12, but instead has either a facemask or a mouthpiece 30 that can connect with a quick connect fitting 36, then the buddy hose 82 can then extend from the fourth port 28 of the first connector 12 directly to the facemask or mouthpiece 30 of the second miner to provide breathable air to the second miner.

The recharge station 44, instead of essentially being a container 46 with air cylinders and connectors 12, can be a changeover station 48 such as that described in U.S. Patent Application Ser. No. 61/827,348, incorporated by reference herein. In such instance, the first miner will enter the COS 48 and obtain the first air cylinder 14, and the first connector 12. The first miner will then connect the third port 26 of the first connector 12 to the changeover valve 34 of the SCSR 32, as described above and connect the first air cylinder 14 to the first port, as described above. By being inside the COS 48, the first miner has the luxury of carrying out this conversion without necessarily having to keep his facemask on.

In the alternative, if the first miner has a standard SCSR 32, and not a modified SCSR 32 as described above, the first miner can discard the standard SCSR 32 once inside the COS 48 and refit himself with a first connector 12 and first air cylinder 14, and a first facemask 18 that connects through the inflow hose 64 directly to the third port 26. The facemask will have all the features of the facemask described above but does not need the mouthpiece 30 since the first facemask 18 will not be used at any time for closed loop breathing. The first miner will then put on the first facemask 18 and take the first connector 12 and the first air cylinder 14 with him when he leaves the COS 48 and continues on his way to the surface. The advantage of the first miner being inside the COS 48 when the first miner refits himself with the first connector 12, the first connector 12 and the first air cylinder 14 is the refit occurs in a safe protected environment. The same refit can occur at a recharge station 44 with a container 46 having the first facemask 18, first air cylinder 14 and first connector 12, where the first miner removes and discards the standard SCSR 32 and puts the first facemask 18 on with the first connector 12 and the first air cylinder 14 to receive air from it, but the first miner could then be in a dangerous environment and would be safest if he holds his breath when he removes the mouthpiece 30 of the SCSR 32 until the first facemask 18 is in place on his head. As reiterated, once the first miner has the first air cylinder 14, the first connector 12 and the first facemask 18 on, the present invention allows the first miner to switch out the first air cylinder 14 with the second air cylinder 16 safely, without having to worry about holding his breath, because the first air cylinder 14 is only discarded after the second air cylinder 16 is connected to the first connector 12 and air is provided to the first facemask 18 from the second air cylinder 16. That is, there is a period of time where there is an overlap of the first and second air cylinders both providing air to the first miner through the first connector 12 and the first facemask 18 so there is then never a time where the first miner is without air supplied to the first facemask 18 he is wearing.

Alternatively, a standard SCSR 32, which does not have a facemask, is modified to have an inflow hose 64 connected to the third port 26 of the connector 12 and the mouthpiece 30 through the changeover valve 34. See FIGS. 7a and 8. The outflow hose 66 has the changeover valve 34 with a port to receive the end of the inflow hose 64 with a quick connect fitting 36, and a pendulum valve 84 position at the port of the changeover valve 34. When not activated to receive the inflow hose 64, the port of the changeover valve 34 remains closed by the pendulum valve 84 positioned to seal the port. When the changeover valve 34 is not activated, the pendulum valve 84 is also not activated and stays fixed to keep the port of the changeover valve closed so air, either exhaled or inhaled by the first miner flows back and forth to the bag in closed loop mode. Once the changeover valve 34 is activated, the pendulum valve 84 opens when the miner breathes in and closes when exhaling. The pendulum valve 84 is positioned so that when it opens to allow air to flow from the inflow hose 64, the pendulum valve 84 closes the outflow hose 66 so air from the bag 50 cannot be drawn in by the miner inhaling. This is important because when the inflow hose 64 is attached to the changeover valve 34, the bag is removed to create the open loop. When the pendulum valve 84 is closed, the exhaled air is directed to the breathing bag 50 that acts as a reservoir, and when the inflow hose 64 is attached, is prevented from entering the inflow hose 64. When the inflow hose is connected to the mouthpiece 30 through the changeover valve 34, and to the third port 26 to receive air from the first port 22 having the first air cylinder 14, the bag 50 of the SCSR 32 is removed. The changeover to the open loop would eliminate the bag and the exhaled air would be directed to the mine atmosphere. With the mouthpiece 30 now connected to the third port 26 of the first connector 12, the first miner can make his way out of the mine as described above, stopping at recharge stations 44 or COSs 48 as necessary, to switch out the first air cylinder 14 with a second air cylinder 16, as described above, as needed. In this case, the first miner will not have a first facemask 18 if he chooses to keep his original mouthpiece 30 in his mouth as he egresses the mine.

FIG. 9 shows the attachment of the inflow hose 64 from the Y fitting 42 carrying air to the SCSR 32. The changeover valve 34 is fitted into the existing outflow hose 66 with the mouthpiece 30 connected to the canister 68 and a bag 50 of the SCSR 32. The changeover valve 34 in the inlet port of the changeover valve 34 that connects to the inflow hose 64, in this embodiment, now has a first one-way valve 90. The changeover valve 34 also has a second one-way valve 92 disposed below the inlet port of the changeover valve 34 in the existing pathway of the outlet hose 66 between the mouthpiece 30 and the bag 50. In operation, when the miner breathes in from the mouthpiece 30, the first one-way valve 90 will open allowing clean air from the inflow hose 66 to be inhaled by the miner, and the second one-way valve 92 will close preventing mine air from being drawn in to the opening where the bag used to be, but has now been removed to create the open loop. Upon exhalation, the first one-way valve 90 will close stopping the flow of air from the Y fitting 42, and the second one-way valve 92 will open allowing the exhalation to flow out of the outflow hose to the mine environment.

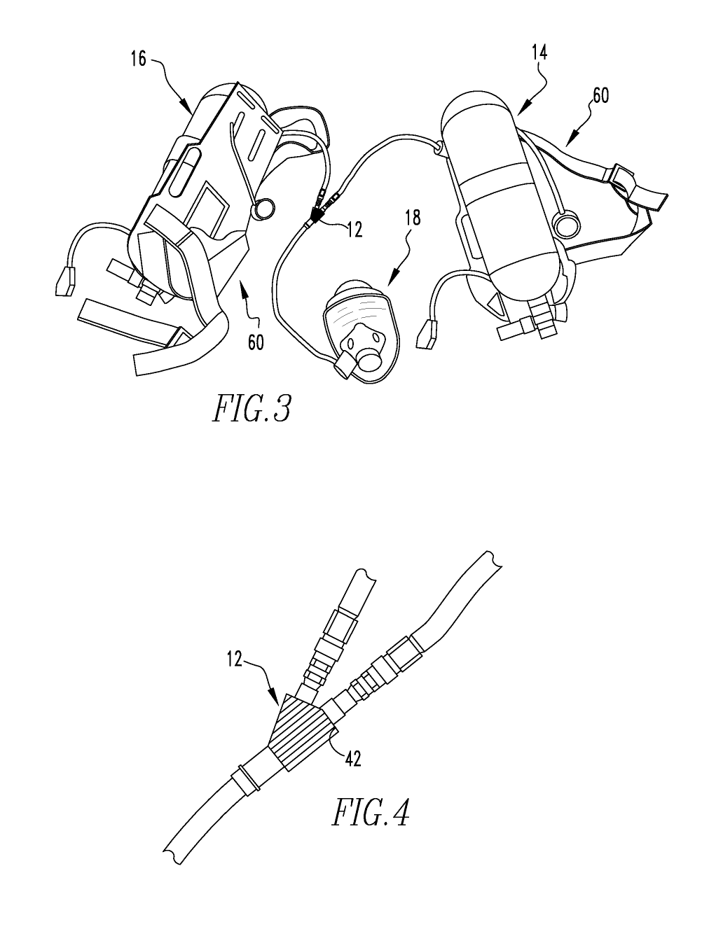

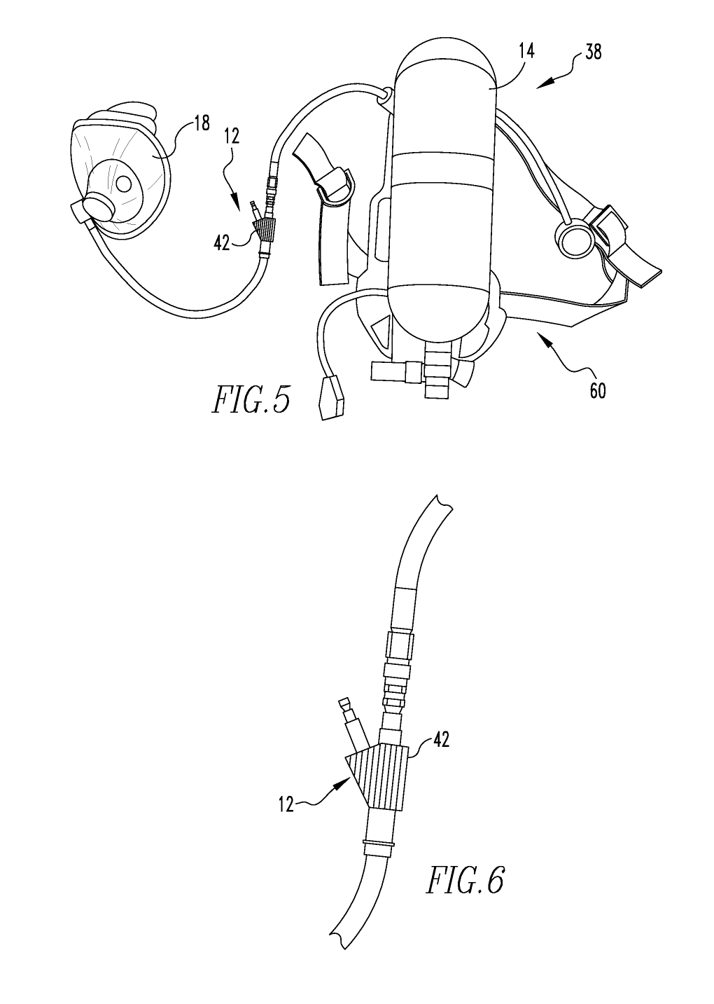

In another embodiment, the first connector 12, first air cylinder 14 and facemask is a standard SCBA 38 with a 4500 psi, 60 minute cylinder, with the connector being a Y fitting 42, more fully described below, which has been added to the demand valve hose of the SCBA 38. See FIG. 3. In this embodiment, there is no fourth port 28, only three ports, so there is no buddy breathing capability. In this embodiment, the second air cylinder 16 that the first miner will use to switch out the first air cylinder 14 when the first air cylinder 14 is depleted is also an SCBA 38 having a second air hose with a quick connect fitting 36 to engage with the second port 24 of the Y fitting 42, but without a facemask. In this embodiment, all the cached cylinders are SCBAs 38 having a second port hose 72 with a quick connect fitting 36 and a sling or backpack 60 but without a facemask. FIG. 4 shows the Y fitting 42 connected to the first air cylinder 14, the second air cylinder 16 and the first facemask 18. FIG. 5 shows a single standard SCBA 38 with a Y fitting 42 only connected to the first air cylinder 14 and the first facemask 18. FIG. 6 shows the Y fitting 42 of FIG. 5 with the second port open and not connected to the second air cylinder 16. As the first miner moves through the mine, the system 10 shown in FIG. 5, is an example of what the first miner will have on him and with him.

If the first miner already has the first connector 12 and first air cylinder 14 when he enters the COS 48, the first miner will obtain the second air cylinder 16 from a cache of air cylinders stored in the COS 48. The first miner will then replace the spent first air cylinder 14 with the second air cylinder 16, as described above. Since the COS 48 provides a protected safe environment, the first miner may also drink water or obtain additional supplies that are stored in the COS 48 before continuing on his trek to escape the mine.

The connector 12 includes a standard Y fitting 42 as shown in FIG. 1a. The Y fitting 42 is designed to allow airflow in one direction by having a one way valve located at each port, with the one way valve oriented to allow flow in the desired direction. In this case the Y fitting 42 is used so the first port 22 and the second port 24 connect with the first cylinder 14 and second cylinder 16, respectively, and receive air therefrom, and allow the air received from either the first port 22 and second port 24 to only flow to and through the third port 26. Air, or for that matter any gas, cannot flow back through the third port 26 toward the first or second ports. As explained above, the first and second ports have first and second port hoses, respectively, each with quick connect fittings 36 to allow them to connect quickly with the first and second air cylinders 16, respectively. The third port 26 has the inflow hose 64 with a quick connect fitting 36 that connects with the facemask. In addition the inflow hose 64 has a split valve 86 that has the buddy hose 82 with a quick connect fitting 36 that extends from the split valve 86 to define the fourth port. Gas flow through the split valve 86 can only go in one direction, away from the third port 26. At the split valve 86, two flow paths are defined. This first flow path continues the inflow hose 64 to the facemask. The second flow path from the split valve with the buddy hose 82 forms the fourth port 28. It is through this fourth port 28 that buddy breathing occurs.

The individual cached air cylinders are each fitted with a pressure reducing valve 74 so that the quick connect can be performed at low pressure, for instance below 20 PSI. The cached air cylinders are fitted with wireless pressure transducers 62 so the pressures in the air cylinders can be monitored remotely during times of storage. The air cylinders are fitted with time or pressure, or both, gauges 56 which indicate how much air and how much time regarding the amount of air in the air cylinder remains. These gauges 56 can be easily read by the miner as he attempts to escape from the mine. The cylinders described above are ideally filled with air, but they can also be filled with oxygen. Alternatively, some of the cylinders can be filled with air and some of the cylinders can be filled with oxygen.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A self-rescuer system for a first miner and a second miner in a mine having an atmosphere comprising:
a first pressurized the gas cylinder;
a second pressurized gas cylinder;
a first facemask that completely encompasses the first miner's eyes, nose and mouth and encloses the first miner's face so a protected environment within the first facemask is created for the first miner to breathe; and
a connector having a first port which connects with the first pressurized gas cylinder, a second port which connects with the second pressurized gas cylinder, and a third port which connects to the first facemask through which gas from either the first port or second port is provided to the first facemask for the first miner to breath.

2. The system of claim 1 wherein the first facemask has a communication diaphragm to amplify voice.

3. The system of claim 2 wherein the first facemask is fitted with wireless communication to communicate with others.

4. The system of claim 3 wherein the connector includes a time or pressure gauge that indicates the time or the pressure remaining in either the first gas cylinder or the second gas cylinder.

5. The system of claim 4 wherein the first gas cylinder and the second gas cylinder are each fitted with a quick connect fitting for easy connection to or disconnection from the connector.

6. The system of claim 5 wherein the first gas cylinder and the second gas cylinder are each fitted with a pressure reducing valve so that connection of the first gas cylinder and the second gas cylinder with the connector occurs at low pressure.

7. The system of claim 6 wherein the first gas cylinder and the second gas cylinder are each fitted with a disposable sling or backpack that is jettisoned with the first gas cylinder or the second gas cylinder when the first gas cylinder or second gas cylinder is disconnected from the connector.

8. The system of claim 7 wherein the first gas cylinder and the second gas cylinder are each fitted with wireless pressure transducers so pressure in the first gas cylinder or the second gas cylinder can be remotely monitored when either the first gas cylinder or the second gas cylinder are in storage.

9. The system of claim 8 wherein the first gas cylinder and the second gas cylinder are made of carbon fiber, steel or aluminum.

10. A method for a first miner in a mine having an atmosphere to breathe in the mine comprising the steps of:
putting a first facemask on the first miner that completely encompasses the first miner's eyes, nose and mouth and encloses the first miner's face so a protected environment within the first facemask is created for the first miner to breathe;
connecting a first port of a connector with a first pressurized gas cylinder, the connector also having a second port which connects with a second pressurized gas cylinder, and a third port which connects to the first facemask through which gas from either the first port or second port is provided to the first facemask for the first miner to breath;
connecting the third port of the connector with the first facemask;
turning on an on off valve of the first air cylinder while in the mine so air flows from the first air cylinder to and through the third port and to the first facemask;
the first miner breathing air in the first facemask from the third port;
connecting the second air cylinder to the second port;
turning on an on off valve of the second air cylinder so air flows from the second air cylinder to and through the third port and to and through the mouthpiece; and
separating the first air cylinder from the first port.

11. The method of claim 10 including the step of the first miner speaking into the first facemask whose voice is amplified by a communication diaphragm to amplify voice.

12. The method of claim 11 including the step of the first miner communicating remotely with others through wireless communication fitted to the first facemask.

13. The method of claim 12 including the step of indicating on a time or pressure gauge the time or the pressure remaining in either the first cylinder or the second cylinder.

14. The method of claim 13 wherein the first cylinder and the second cylinder are each fitted with a quick connect fitting for easy connection to or disconnection from the connector.

15. The method of claim 14 wherein the first cylinder and the second cylinder are each fitted with a pressure reducing valve so that connection of the first cylinder and the second cylinder with the connector occurs at low pressure.

16. The method of claim 15 wherein the first cylinder and the second cylinder are each fitted with a disposable sling or backpack that is jettisoned with the first cylinder or the second cylinder when the first cylinder or second cylinder is disconnected from the connector.

17. The method of claim 16 including the step of monitoring remotely with wireless pressure transducers attached to the first and second air cylinders pressure in the first cylinder or the second cylinder when either the first cylinder or the second cylinder are in storage.

18. The method of claim 17 including the steps of the first miner moving in the mine to a recharge station in the mine, and taking from a container at the recharge station the second gas cylinder to connect to the second port of the connector.

19. A method for a first miner and a second miner in a mine having an atmosphere to breathe in the mine comprising the steps of:
putting a first facemask on the first miner that completely encompasses the first miner's eyes, nose and mouth and encloses the first miner's face so a protected environment within the first facemask is created for the first miner to breathe, the first facemask supporting closed loop breathing and open loop breathing and having a changeover valve to convert from closed loop breathing to open loop breathing, the first facemask having a mouthpiece that is spit out by the first miner when the first facemask is converted from closed loop breathing to open loop breathing;
connecting a first port of a connector with a first pressurized gas cylinder, the connector also having a second port which connects with a second pressurized gas cylinder, a third port which connects to the first facemask through which gas from either the first port or second port is provided to the first facemask for the first miner to breath; and a fourth port which connects with a second facemask on the second miner through which gas from either the first port or second port is provided to the second facemask for the second miner to breath simultaneously while gas is provided to the first facemask;
connecting the third port of the connector with the first facemask;
turning on an on off valve of the first air cylinder so air flows from the first air cylinder to and through the third port and to and through the mouthpiece;
the first miner spitting out the mouthpiece in his mouth and breathing air in the first facemask from the mouthpiece;
connecting the second air cylinder to the second port;
turning on an on off valve of the second air cylinder so air flows from the second air cylinder to and through the third port and to and through the mouthpiece;
separating the first air cylinder from the first port;
connecting the fourth port to the second facemask on the second miner so air from the connector flows through the fourth port to the second facemask; and
the second miner breathing air in the second facemask from the connector simultaneously while the first miner is breathing air from the third port.

20. A self-rescuer system for a first miner and a second miner in a mine having an atmosphere comprising:
a first pressurized the gas cylinder;
a second pressurized gas cylinder;
a first facemask that completely encompasses the first miner's eyes, nose and mouth and encloses the first miner's face so a protected environment within the first facemask is created for the first miner to breathe, the first facemask supporting closed loop breathing and open loop breathing and having a changeover valve to convert from closed loop breathing to open loop breathing, the first facemask having a mouthpiece that is spit out by the first miner when the first facemask is converted from closed loop breathing to open loop breathing;
a second facemask that completely encompasses the second miner's eyes, nose and mouth and encloses the second miner's face so a protected environment within the second facemask is created for the second miner to breathe, the second facemask supporting closed loop breathing and open loop breathing and having a changeover valve to convert from closed loop breathing to open loop breathing, the second facemask having a mouthpiece that is spit out by the second miner when the second facemask is converted from closed loop breathing to open loop breathing; and
a connector having a first port which connects with the first pressurized gas cylinder, a second port which connects with the second pressurized gas cylinder, a third port which connects to the first facemask through which gas from either the first port or second port is provided to the first facemask for the first miner to breath, and a fourth port which connects with the second facemask through which gas from either the first port or second port is provided to the second facemask for the second miner to breath simultaneously while gas is provided to the first facemask.

21. A method for a first miner in a mine having an atmosphere to breathe in the mine comprising the steps of:
turning on an on off valve of a first air cylinder while in the mine so air flows from the first air cylinder connected to a first port of a connector to and through a third port of the connector and to a first facemask on the first miner's head;
the first miner breathing air in the first facemask from the third port;
connecting a second air cylinder to a second port of the connector;
turning on an on off valve of the second air cylinder while in the mine so air flows from the second air cylinder to and through the third port and to the first facemask so the first miner is breathing air in the first facemask from the first and second air cylinders; and
separating the first air cylinder from the first port while in the mine.
